(19) United States
(12) Patent Application Publication
(10) Pub. No.: US 2015/0095889 A1
(43) Pub. Date: Apr. 2, 2015

(54) EVALUATION SYSTEM, EVALUATION DEVICE, AND EVALUATION METHOD

(71) Applicants: BIGLOBE Inc., Tokyo (JP); NEC Solution Innovators, Ltd., Tokyo (JP)

(72) Inventors: Kazuaki Kawahara, Tokyo (JP); Yasuhiro Kakita, Tokyo (JP)

(73) Assignees: NEC Solution Innovators, Ltd., Tokyo (JP); BIGLOBE INC., Tokyo (JP)

(21) Appl. No.: 14/498,258

(22) Filed: Sep. 26, 2014

(30) Foreign Application Priority Data
Sep. 30, 2013 (JP) 2013-203799

(51) Int. Cl. G06F 11/36

(52) U.S. Cl. CPC G06F 11/3688
USPC 717/124

(57) ABSTRACT

A test using a virtual date and time is to be performed without restriction imposed, depending on the implementation status of another test using a virtual date and time. A control section 220 outputs a specified layer identifier and a date and time conversion instruction. Then, when the date and time conversion instruction has been outputted from the control section 220, a date and time conversion section 230 acquires the present date and time from a clock 210, then reads, from a layer storage section 100, conversion definition information corresponding to the layer identifier outputted from the control section 220, then by using the read-out conversion definition information, converts the present date and time acquired from the clock 210, and then outputs, to the control section 220, virtual date and time information indicating the date and time obtained by conversion. Then, by using the date and time indicated by the virtual date and time information outputted from the date and time conversion section 230, the control section 220 executes predetermined processing.

This application is based upon and claims the benefit of priority from Japanese patent application No. 2013-203799, filed on Sep. 30, 2013, the disclosure of which is incorporated herein in its entirety by reference.

### BACKGROUND OF THE INVENTION

1. Field of the Invention

The present invention relates to a technique of performing evaluation of a system.

2. Related Art

In recent years, a test system is proposed that performs an operation test on a system by using a local date and time. Such a test system is disclosed in Japanese Laid-Open Patent Publication No. 2008-234276 or the like. When this test system is employed, the test can be performed without the necessity of waiting until a date and time when each operation is to be started.

### SUMMARY OF THE INVENTION

In a test system, until one test (one job) is completed, another test cannot be executed. Thus, in the course of execution of a test using a particular local date and time (a virtual date and time), when, another test using another local date and time (another virtual date and time) is executed, a possibility arises that a correct test result cannot be obtained. This causes a problem that the test using a virtual date and time could suffer restriction depending on the execution status of the another test using a virtual date and time.

An object of the present invention is to resolve the above-mentioned problem.

An evaluation system according to the present invention comprises:
layer storage means for storing in advance in correspondence to each other a layer identifier and conversion definition information used for converting a date and time;
a clock indicating a present date and time;
control means for outputting a specified layer identifier and a date and time conversion instruction; and
date and time conversion means for, when the date and time conversion instruction has been outputted from the control means, acquiring a present date and time from the clock, then on the basis of the layer identifier outputted from the control means, reading, from the layer storage means, conversion definition information corresponding to the layer identifier, then by using the read-out conversion definition information, converting the acquired present date and time, and then outputting, to the control means, virtual date and time information indicating the date and time obtained by conversion, wherein
the control means executes predetermined processing by using the date and time indicated by the virtual date and time information outputted from the date and time conversion means.

An evaluation device according to the present invention comprises:
a clock indicating a present date and time;
a control section for outputting a specified layer identifier and a date and time conversion instruction; and
a date and time conversion section for, when the date and time conversion instruction has been outputted from the control section, acquiring a present date and time from the clock, then on the basis of the layer identifier outputted from the control section, acquiring conversion definition information serving as information defined in advance for the purpose of conversion of a date and time, then by using the acquired conversion definition information, converting the acquired present date and time, and then outputting, to the control section, virtual date and time information indicating the date and time obtained by conversion, wherein
the control section executes predetermined processing by using the date and time indicated by the virtual date and time information outputted from the date and time conversion section.

An evaluation method according to the present invention comprises:
the step of an evaluation device, on the basis of the specified layer identifier, acquiring conversion definition information for the purpose of conversion of a date and time;
the step of the evaluation device acquiring a present date and time;
the step of the evaluation device, by using the acquired conversion definition information, converting the acquired present date and time; and
the step of the evaluation device, by using the date and time obtained by conversion, executing predetermined processing.

According to the present invention, a test using a virtual date and time can be performed without restriction imposed depending on the implementation status of another test using a virtual date and time.

### BRIEF DESCRIPTION OF THE DRAWINGS

FIG. 1 is a diagram showing a first embodiment of an evaluation system according to the present invention.

FIG. 2 is a diagram showing an example of a correspondence relation stored in a layer storage section shown in FIG 1.

FIG. 3 is a flow chart used for describing an evaluation method in an evaluation system shown in FIG. 1.

FIG. 4 is a diagram showing a second embodiment of an evaluation system according to the present invention.

FIG. 5 is a diagram showing an example of a correspondence relation in a case that a layer storage section shown in FIG. 4 stores information indicating a predetermined date and time as conversion definition information.

FIG. 6 is a diagram showing an example of a correspondence relation in a case that a layer storage section shown in FIG. 4 stores difference information as conversion definition information.

FIG. 7 is a diagram showing an example of a correspondence relation in a case that a layer storage section shown in FIG. 4 stores virtual date and time information or difference information as conversion definition information.

FIG. 8 is a diagram showing an example of description of a program shown in FIG. 4.

FIG. 9A is a sequence diagram used for describing an evaluation method in an evaluation system shown in FIG. 4.

FIG. 9B is a sequence diagram used for describing an evaluation method in an evaluation system shown in FIG. 4.

FIG. 10 is a diagram showing an example of a correspondence relation in a case that a layer storage section shown in FIG. 4 stores conversion definition information different for each module.

FIG. 11 is a diagram showing an example of an API stored as a module in a module storage section shown in FIG. 4.

FIG. 12 is a diagram showing an example of a layer definition stored in a layer storage section shown in FIG 4.

FIG. 13 is a diagram showing an example of an accounting program.

FIG. 14 is a flow chart used for describing processing in a case that a layer definition shown in FIG. 12 is defined in a layer storage section and then an accounting program shown in FIG. 13 is executed.

### DESCRIPTION OF THE EMBODIMENTS

An evaluation system according to the present invention is a system for testing the contents of a provided service in a system (a service system, hereinafter) for providing the service. Embodiments of the present invention are described below with reference to the drawings.

### First Embodiment

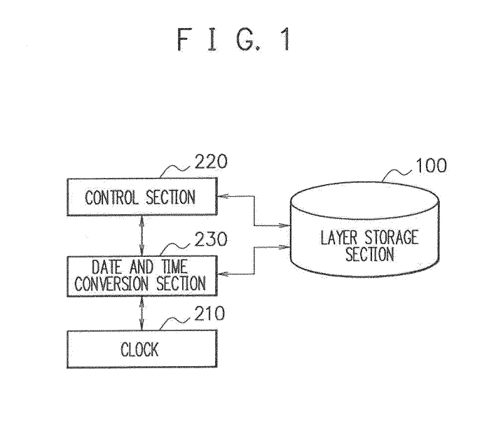

FIG. 1 is a diagram showing a first embodiment of an evaluation system according to the present invention.

In the present embodiment, as shown in FIG. 1, a configuration is employed that includes a layer storage section 100, a clock 210, a control section 220, and a date and time conversion section 230.

The layer storage section 100 serves as the layer storage means for storing in advance in correspondence to each other a layer identifier and information (conversion definition information) defined in advance for the purpose of conversion of a date and time.

The clock 210 indicates the present date and time. It is sufficient that the clock 210 can indicate the present date and time. Thus, the clock 210 may be a common clock.

The control section 220 serves as the control means for outputting a specified layer identifier to the date and time conversion section 230. Further, by using a date and time indicated by virtual date and time information outputted from the date and time conversion section 230, the control section 220 executes processing specified in correspondence to the specified layer identifier.

The date and time conversion section 230 acquires the present date and time from the clock 210. Further, on the basis of the layer identifier outputted from the control section 220, the date and time conversion section 230 reads, from the layer storage means 100, conversion definition information corresponding to the layer identifier. Further, the date and time conversion section 230 serves as the date and time conversion means for, by using the conversion definition information read from the layer storage section 100, converting the present date and time acquired from the clock 210. Further, the date and time conversion section 230 outputs, to the control section 220, virtual date and time information indicating the date and time obtained by conversion.

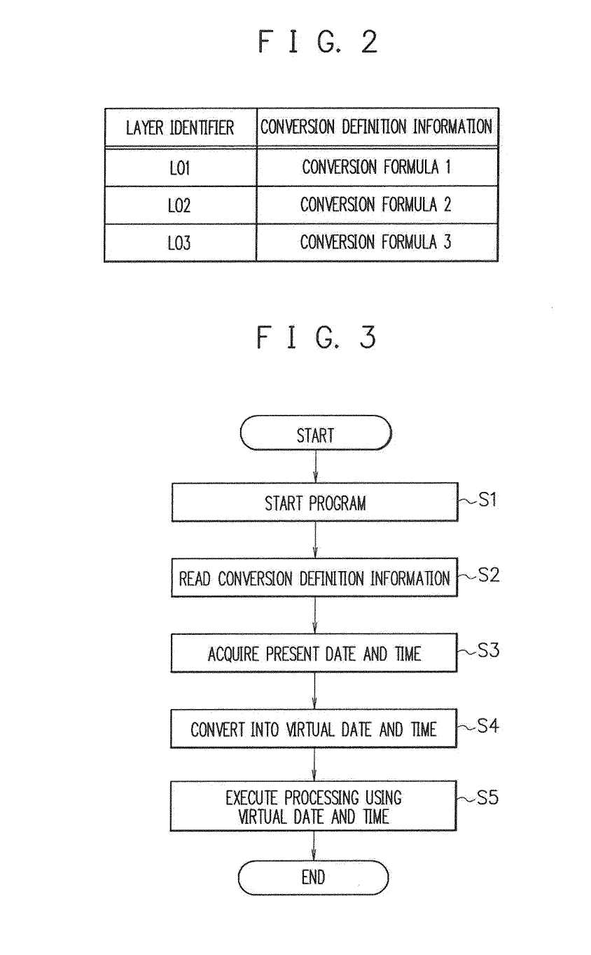

FIG. 2 is a diagram showing an example of a correspondence relation stored in the layer storage section 100 shown in FIG. 1.

As shown in FIG. 2, in the layer storage section 100 shown in FIG. 1, a plurality of layer identifiers are stored individually in correspondence to conversion definition information set up in advance. The layer identifier is an identifier for specifying a conversion definition used when the control section 220 executes processing (a program). It is sufficient that each layer can be identified. Thus, the method of imparting a layer identifier is not limited to a particular one. Further, the conversion definition information is a conversion definition (a conversion formula) describing how to convert the present date and time indicated by the clock 210.

As shown in FIG. 2, for example, a layer identifier “L01” and conversion definition Information “conversion formula 1” are stored in correspondence to each other. Thus, when the layer identifier “L01” is specified in the program executed by the control section 220, the date and time conversion section 230 converts the present date and time by using the conversion formula 1. Further, a layer identifier “L02” and conversion definition information “conversion formula 2” are stored in correspondence to each other. Thus, when the layer identifier “L02” is specified in the program executed by the control section 220, the date and time conversion section 230 converts the present date and time by using the conversion formula 2. Further, a layer identifier “L03” and conversion definition information “conversion formula 3” are stored in correspondence to each other. Thus, when the layer identifier “L03” is specified in the program executed by the control section 220, the date and time conversion section 230 converts the present date and time by using the conversion formula 3.

An evaluation method in the present embodiment is described below.

FIG. 3 is a flow chart used for describing an evaluation method in the evaluation system shown in FIG 1.

First, the control section 220 starts a program (step S1), and then during the execution of the program, outputs a specified layer identifier and a date and time conversion instruction to the date and time conversion section 230. Here, the layer identifier may be one specified by the program, or alternatively may be one specified in advance by input from the outside at the time of execution of the program. Further, the layer identifier may be one specified by a function call using a function described in the program.

Then, on the basis the layer identifier outputted from the control section 220, the date and time conversion section 230 searches the layer storage section 100 and thereby reads, from the layer storage section 100, conversion definition information corresponding to the layer identifier outputted from the control section 220 (step S2). Further, the date and time conversion section 230 acquires the present date and time from the clock 210 (step S3). Then, the date and time conversion section 230 converts the acquired date and time into a virtual date and time by using the conversion definition information read from the layer storage section 100 (step S4). The date and time conversion section 230 outputs virtual date and time information indicating the virtual date and time, to the control section 220.

Then, the control section 220 executes processing by using the virtual date and time indicated by the virtual date and time information outputted from the date and time conversion section 230 (step S5). The processing executed at that time is the processing corresponding to the specified layer identifier in the started program.

As such, when the started program need execute processing by using a virtual date and time, in place of changing the date and time itself of the clock, provided in the system (the device), first, the present date and time is read from the clock. Then, the read-out date and time is converted on the basis of the layer specified by the program and then the processing is performed by using the converted date and time. Thus, when a test is to be performed on a system or a device by using the program, the test can be performed without restriction imposed depending on the implementation status of another test.

### Second Embodiment

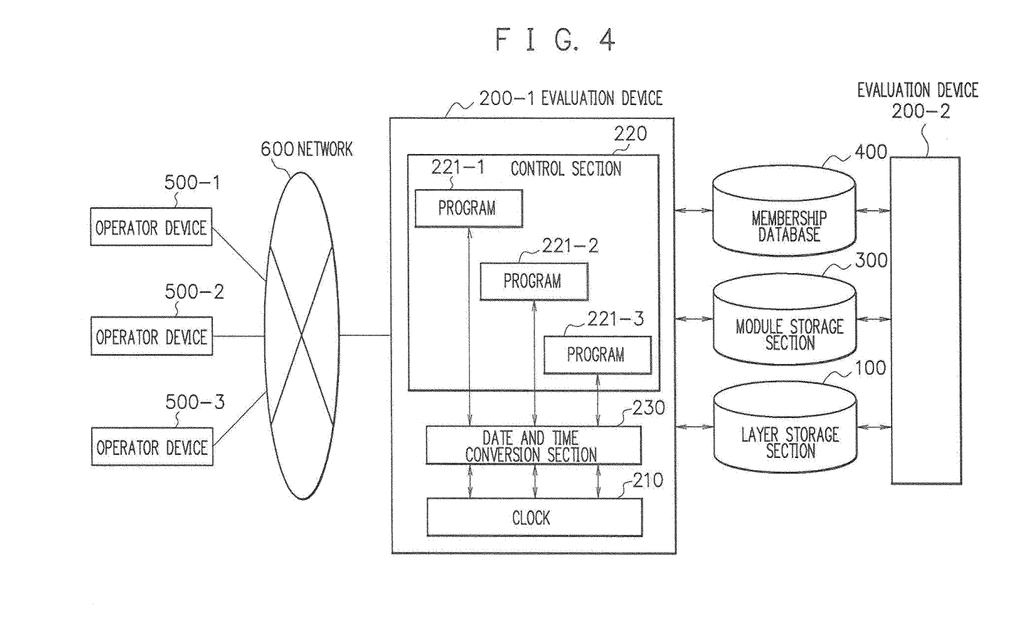

FIG. 4 is a diagram showing a second embodiment of an evaluation system according to the present invention. The second embodiment is a detailed embodiment of the first embodiment.

As shown in FIG. 4, in the present embodiment, a configuration is employed that includes a layer storage section 100, evaluation devices 200-1 and 200-2, a module storage section 300, a membership database 400, and operator devices 500-1 to 500-3.

Similar to the first embodiment, in the layer storage section 100, a layer identifier and information (conversion definition information) defined in advance for the purpose of conversion of a date and time are stored in advance in correspondence to each other. Here, the layer storage section 100 may store information indicating a predetermined date and time as conversion definition information, or alternatively may store difference information. Further, the layer storage section 100 stores a plurality of such correspondence relations. Further, each correspondence relation is added, updated, or deleted on the basis of information transmitted from the operator devices 500-1 to 500-3. That is, each correspondence relation can be edited by using the operator devices 500-1 to 500-3. Further, the layer storage section 100 may be provided in the evaluation devices 200-1 and 200-2.

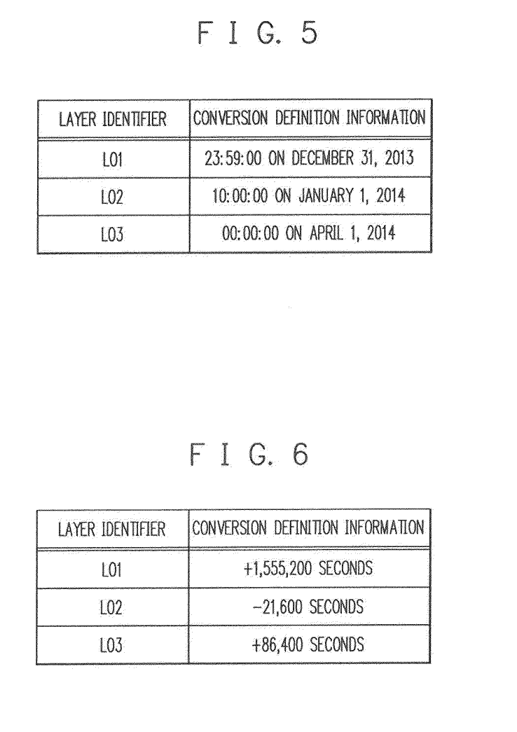

FIG 5 is a diagram showing an example of a correspondence relation in a case that the layer storage section 100 shown in FIG. 4 stores information indicating a predetermined date and time as conversion definition information.

As shown in FIG 5, in the layer storage section 100 shown in FIG. 4, a layer identifier and information indicating a predetermined date and time serving as conversion definition information are stored in correspondence to each other. The information indicating a predetermined date and time is information indicating a date and time necessary for the processing executed by the program. For example, when the processing to be executed by the program is processing to be performed at the beginning of each month, the information indicating a predetermined date and time is information indicating the date and time of the beginning of each month. When the processing to be executed by the program is processing to be performed at the end of each year, the information is information indicating the date and time of the end of each year.

As shown in FIG. 5, for example, a layer identifier “L01” and conversion definition information “23:59:00 on Dec. 31, 2013” are stored in correspondence to each other. Thus, when the layer identifier “L01” is specified in the program executed by the control section 220, the date and time conversion section 230 converts the present date and time acquired from the clock into “23:59:00 on Dec. 31, 2013”. Further, a layer identifier “L02” and conversion definition, information “10:00:00 on Jan. 1, 2014” are stored in correspondence to each other. Thus, when the layer identifier “L02” is specified in the program executed by the control section 220, the date and time conversion section 230 converts the present date and time acquired from the clock into “10:00:00 on Jan. 1, 2014”. Further, a layer identifier “L03” and conversion definition information “00:00:00 on Apr. 1, 2014” are stored in correspondence to each other. Thus, when the layer identifier “L03” is specified in the program executed by the control section 220, the date and time conversion section 230 converts the present date and time acquired from the clock into “00:00:00 on Apr. 1, 2014”.

FIG. 6 is a diagram showing an example of a correspondence relation in a case that the layer storage section 100 shown in FIG. 4 stores difference information as conversion definition information.

As shown in FIG. 6, in the layer storage section 100 shown in FIG. 4, a layer identifier and difference information serving as conversion definition information, are stored in correspondence to each other. The difference information is information indicating a difference between the present date and time acquired from the clock by the date and time conversion section 230 and the date and time obtained by conversion.

As shown in FIG. 6. for example, a layer identifier “L01” and conversion definition information “+1555200 seconds” are stored in correspondence to each other. Thus, when the layer identifier “L01” is specified in the program executed by the control section 220, the date and time conversion section 230 converts the present date and time acquired from the clock into a date and time obtained by adding “1555200 seconds” to the present date and time. Further, a layer identifier “L02” and conversion definition information “−21600 seconds” are stored in correspondence to each other. Thus, when the layer identifier “L02” is specified in the program executed by the control section 220, the date and time conversion section 230 converts the present date and time acquired from the clock into a date and time obtained by subtracting “21600 seconds” from the present date and time. Further, a layer identifier “L03” and conversion definition information “+86400 seconds” are stored in correspondence to each other. Thus, when the layer identifier “L03” is specified in the program executed by the control section 220, the date and time conversion section 230 converts the present date and time acquired from the clock into a date and time obtained by adding “86400 seconds” to the present date and time.

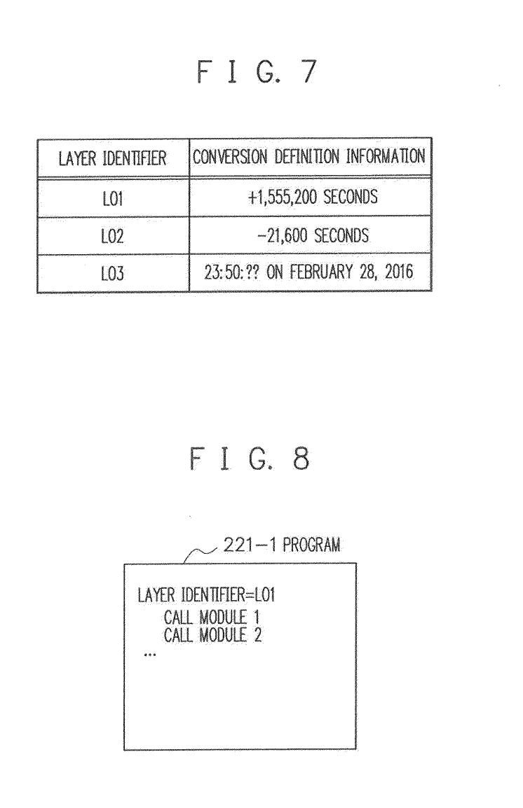

FIG. 7 is a diagram showing an example of a correspondence relation in a case that the layer storage section 100 shown in FIG. 4 stores virtual date and time information or difference information as conversion definition information.

As shown in FIG. 7, in the layer storage section 100 shown in FIG. 4, a layer identifier and virtual date and time information or difference information serving as conversion definition information are stored In correspondence to each other. Layer identifiers “L01” and “L02” are stored in correspondence to difference information. Further, a layer identifier “L03” is stored in correspondence to virtual date and time information. As such, conversion definition information stored in the layer storage section 100 may be virtual date and time information or, alternatively, difference information. Further, these kinds of information may be used in a mixed manner.

An example of processing of the date and time conversion section 230 is described below for a case that, as shown in FIG. 7, the conversion definition information stored in the layer storage section 100 in correspondence to the layer identifier “L03” is virtual date and time information and then the layer identifier “L03” is specified, for example, in a program executed by the control section 220. In a module called by the control section 220 within the program, in a case that that the present date and time indicated by the clock 210 is 13:30:20 on May 14, 2013, when the date and time conversion section 230 acquires the present date and time, the date and time conversion section 230 returns a virtual date and time 23:50:20 on Feb. 28, 2016 to the control section 220 (the part of seconds is identical). The date and time conversion section 230 calculates a difference +88165200 seconds between the present date and time at that time and the virtual date and time, and then stores the value in correspondence to the job of the program. Then, 11 minutes later, that is, at the time that the present date and time is 13:41:20 on May 14, 2013, when the date and time conversion section 230 acquires the present date and time in a module called next within the same program by the control section 220, in a case that the job is the same, the date and time conversion section 230 calculates a system time by using the stored difference and then returns a virtual date and time 00:01:20 on Feb. 29, 2016 to the control section 220.

The evaluation devices 200-1 and 200-2 are devices for performing evaluation (a test) in response to an instruction transmitted from the operator devices 500-1 to 500-3 through a network 600 serving as a communication network. Further, the evaluation devices 200-1 and 200-2 need not have all functions and performance provided in a device (referred to as a commercial device or the like, hereinafter) such as a commercial device used for providing a service. Namely, it is sufficient that the evaluation devices 200-1 and 200-2 have functions and performance necessary for performing a test or evaluation concerning the operation of a commercial device or the like. That is, the evaluation devices 200-1 and 200-2 are computers such as server computers for performing operation similarly to a commercial device that executes a program so as to provide a service to a service user's terminal and thereby performing evaluation, of a developed program before execution on a commercial device. Further, the evaluation device 200-1 includes a clock 210, a control section 220, and a date and time conversion section 230. These components are the same as those in the first embodiment.

The control section 220 stores a plurality of programs 221-1 to 221-3 used for performing evaluation of the evaluation device 200-1. For example, the control section 220 is constructed from a CPU (Central Processing Unit) and a memory and may read the programs 221-1 to 221-3 from the memory when the CPU starts up. The programs 221-1 to 221-3 may be transmitted from the operator devices 500-1 to 500-3. Further, in response to an instruction transmitted from an operator device 500-1 to 500-3, the control section 220 starts the programs 221-1 to 221-3 and then transmits a result of execution of the processing to the operator device 500-1 to 500-3 having transmitted the instruction.

The programs 221-1 to 221-3 describe which module is to be executed in what order in what way by using the value of which definition. Here, a plurality of programs may be executed for a single piece of processing. Further, information indicating which program is to be executed in correspondence to an instruction transmitted to the evaluation devices 200-1 and 200-2, that is, a correspondence relation between the instruction and the program, is stored in advance in the memory.

The evaluation device 200-2 also includes the components provided in the evaluation device 200-1 shown in FIG. 4. Here, the embodiment shown in FIG. 4 has been described for an exemplary case that two evaluation devices are employed. However, the number of employed devices is not limited to a particular value and may be one or, alternatively, three or more. Further, selection of a device on which evaluation is to be performed in response to an instruction transmitted from an operator device 500-1 to 500-3 may be performed on the basis of the instruction transmitted from the operator device 500-1 to 500-3, or alternatively may be performed on the basis of the processing load of the evaluation devices 200-1 and 200-2. Here, the layer definition described in the program whose evaluation has been performed by the evaluation devices 200-1 and 200-2 may be copied intact into the program in the commercial device and then the program may be executed. This is because the date and time conversion section provided in the commercial device nullifies the transmitted layer identifier and hence the date and time read from the clock is returned intact to the program.

The module storage section 300 stores a plurality of modules called by the programs 221-1 to 221-3 executed by the control section 220. These modules are called from the programs 221-1 to 221-3 and thereby perform a predetermined calculation or read and write of data. Each module can be called for general purposes from a plurality of the programs and, for example, is an API (Application Program Interface), a set of instructions and functions, a small-size program, or the like. Further, each module may be described in the contents of a program so that the program and the module may be integrated with each other.

The membership database 400 stores information concerning each member who uses the service system. For example, the information concerning the member is information indicating a member ID imparted to each member; and the name, the contact address, the using state of service, and the like of the member.

The operator devices 500-1 to 500-3 are communication terminals operated by operators who belong to a development division, a design division, a maintenance division, or the like, and perform a test or evaluation of a system, a device, a processing procedure, a program, a module, or the like for providing a service. The operator devices 500-1 to 500-3 can be connected to the evaluation devices 200-1 and 200-2, the layer storage section 100, the module storage section 300, and the membership database 400 through the network 600. Further, the operator devices 500-1 to 500-3 transmit, a program inputted by an operator, to the evaluation devices 200-1 and 200-2. Further, the operator devices 500-1 to 500-3 transmit an instruction corresponding to the operation of an operator, to an evaluation device 200-1 or 200-2 serving as an evaluation object. Further, the operator devices 500-1 to 500-3 output the result of processing transmitted from the evaluation devices 200-1 and 200-2. This method of output may be screen display, voice output, or printing. Further, the operator devices 500-1 to 500-3 transmit a layer definition setting forth the correspondence between the layer identifier and the conversion definition information, to the layer storage section 100 directly or alternatively through the evaluation devices 200-1 and 200-2. The layer storage section 100 stores the layer definition. Here, the operator devices 500-1 to 500-3 may include conversion definition generation means for generating conversion definition information. When an operator inputs into an operator device 500-1 to 500-3 a virtual date and time at which evaluation is desired to be performed, the conversion definition generation means may calculate a time difference between the present date and time and the virtual date and time (e.g., in the unit of second or in the unit of day and hour) and then generate conversion definition information on the basis of the calculated result. Alternatively, the conversion definition generation means may generate conversion definition information with specifying this date and time of this year and the absolute date and time. Further, the conversion definition generation means may use the part of minutes and the part of seconds of the present time. Here, the embodiment shown in FIG. 4 has been described for an exemplary case that three operator devices are employed. However, the number of employed devices is not limited to a particular value.

An evaluation method in the present embodiment is described below.

FIG. 8 is a diagram showing an example of description of the program 221-1 shown in FIG. 4.

As shown in FIG. 8, in the program 221-1, the layer identifier “L01” is specified and instructions of calling modules 1 and 2 are contained. That is, in the program 221-1, the modules 1 and 2 are executed by using a date and time obtained by conversion using the layer identifier “L01”.

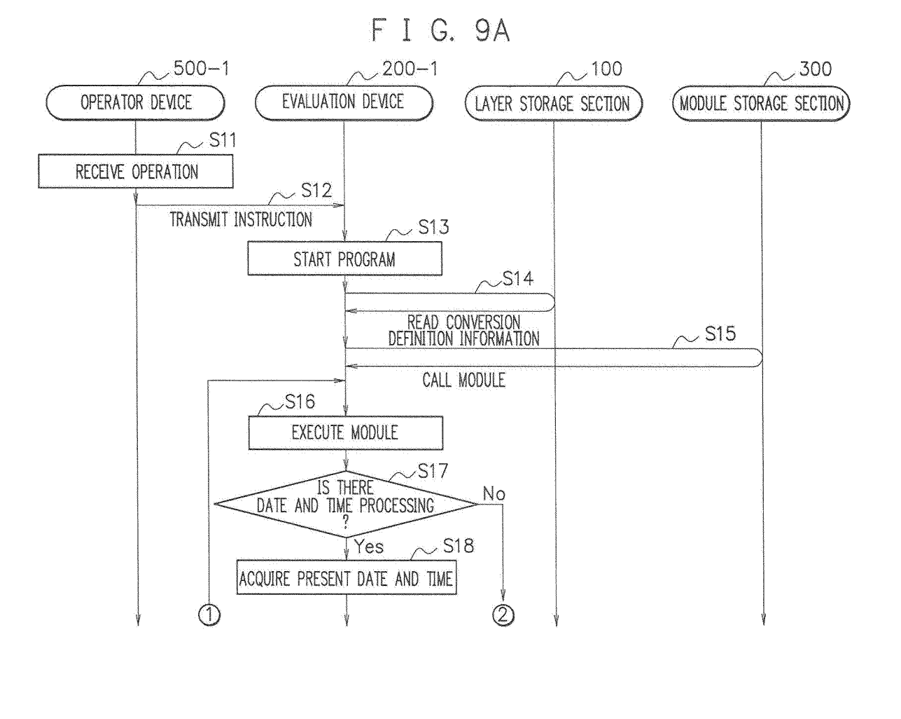

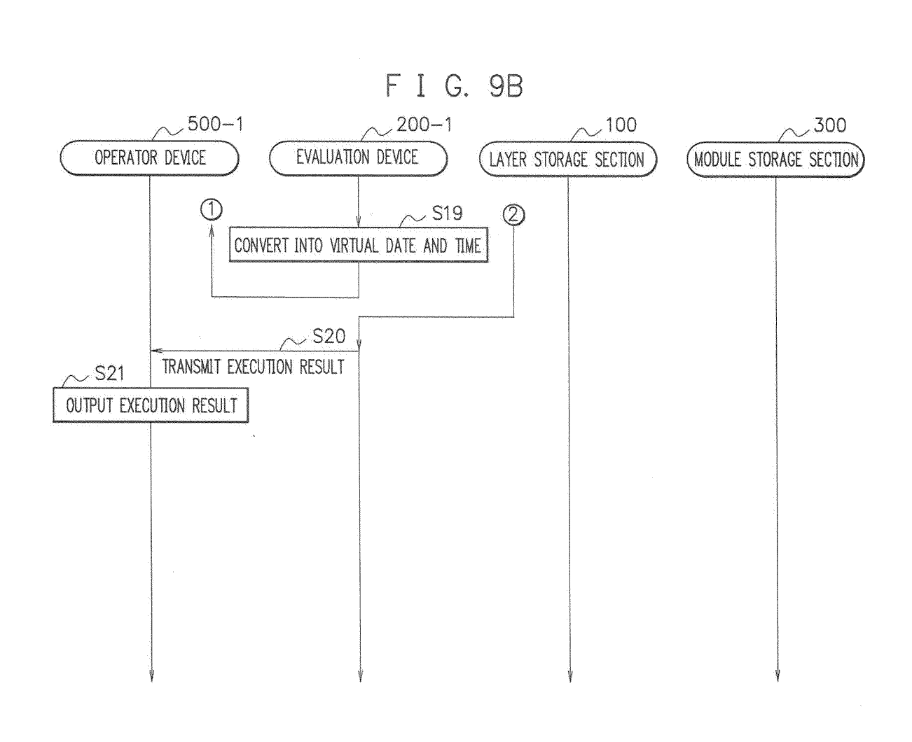

FIGS. 9A and 9B are sequence diagrams used for describing an evaluation method in the evaluation system shown in FIG 4. The flowing description is given for an exemplary case that the operator device 500-1 receives the operation of an operator and the evaluation device 200-1 serves as an evaluation object. Further, the description is for an exemplary case that the control section 220 executes the program 221-1 shown in FIG 8.

First when the operator device 500-1 receives a predetermined operation for starting a test (step S11), the operator device 500-1 transmits an instruction corresponding to the operation, to the evaluation device 200-1 (step S12). This operation is input operation of a processing instruction containing a member ID and a service identifier for identifying a service to be provided to the member. For example, similarly to a case that a service is provided to the member, the operator device 500-1 displays a GUI (Graphical User Interface) for prompting input such as a login screen and a selection screen and then, depending on whether input, selection, or the like has been performed in the screen, transmits a processing instruction to the evaluation device 200-1. When the control section 220 receives the transmitted instruction, the control section 220 starts the program 221-1 corresponding to the instruction (step S13). Here, on the basis of instructions of a plurality of members, the control section 220 executes a plurality of individual programs. Thus, the control section 220 need be capable of identifying that the execution of each program is based on which processing instruction, which member ID, and which service identifier. Thus, the control section 220 may administer each program as a job by using a unique job identifier.

In the course of execution of the started program 221-1, the control section 220 outputs the layer identifier specified by the program to the date and time conversion section 230. Then, the date and time conversion section 230 reads, from the layer storage section 100, conversion definition information corresponding to the layer identifier outputted from the control section 220 (step S14). Here, the program 221-1 has description shown in FIG. 8. Thus, the date and time conversion section 230 reads, from the layer storage section 100, conversion definition information corresponding to the layer identifier “L01”.

Then, the control section 220 calls the module 1 described in the program under execution, from the module storage section 300 (step S15) and then executes the module 1 (step S16). During the execution of the module, the control section 220 judges whether any processing of reading the present date and time is present (step S17). In the case of presence of processing of reading the present date and time, the control section 220 outputs a date and time conversion instruction to the date and time conversion section 230.

Then, the date and time conversion section 230 acquires the present date and time from the clock 210 (step S18). Then, the date and time conversion section 230 converts the acquired date and time into a virtual date and time by using the conversion definition information read from the layer storage section 100 (step S19). Then, the date and time conversion section 230 outputs virtual date and time information indicating the virtual date and time, to the control section 220. Then, the control section 220 executes the processing of the module 1 by using the virtual date and time indicated by the virtual date and time information outputted from the date and time conversion section 230. The control section 220 performs the processing of steps S15 to S19 also for the module 2.

In the description given above, when the program has been executed and then the control section 220 has read the layer identifier defined in the program, the control section 220 has outputted the layer identifier to the date and time conversion section 230. Instead, the control section 220 may transmit the layer identifier in a state of being contained in the date and time conversion instruction, at the time of outputting the date and time conversion instruction to the date and time conversion section 230. In this case, after step S17, the date and time conversion section 230 performs the processing of step S14 at a timing between the receiving of the date and time conversion instruction and step S19.

When a part or all of the programs have been completed, the control section 220 transmits the execution result to the operator device 500-1 through the network 600 (step S20). Here, the control section 220 may store the execution result into a memory or a database, then when an acquisition request for the execution result is transmitted from the operator device 500-1, read the execution result from the memory or the database and then transmit the execution result to the operator device 500-1.

The operator device 500-1 outputs the execution result transmitted from the control section 220 (step S21). At that time, the operator device 500-1 may display the execution result with adopting as a trigger the timing of the execution result being transmitted. Alternatively, the transmitted execution result may be temporarily stored into a memory in the device, then when a predetermined input is received from the operator, the execution result may be read from the memory and then displayed. Further, at that time, the operator device 500-1 may read data or the like stored in an associated membership database and then display the data or the like together with the execution result. Further, the operator device 500-1 may compare the transmitted execution result with an expected result value set up in advance and then display the result of comparison.

As such, the evaluation device converts the present date and time into a virtual date and time by using the layer definition specified by each program. Thus, when a plurality of layer definitions are set up in advance, each program can perform the processing by using mutually different virtual times.

### Third Embodiment

Further, the layer storage section 100 shown in FIG. 4 may store conversion definition information different for each module. A third, embodiment that the layer storage section 100 shown in FIG. 4 stores conversion definition information different for each module is described below. The configuration of the third embodiment, is the same as that shown in FIG. 4.

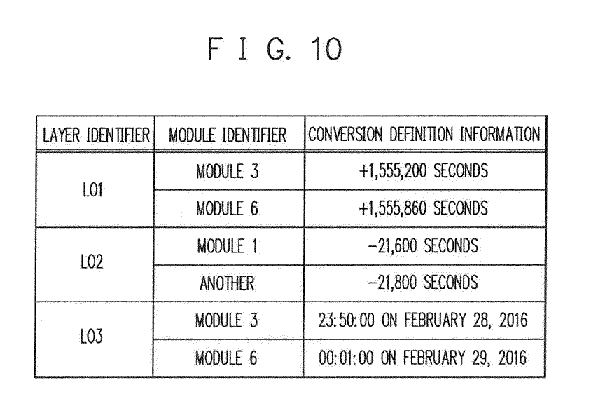

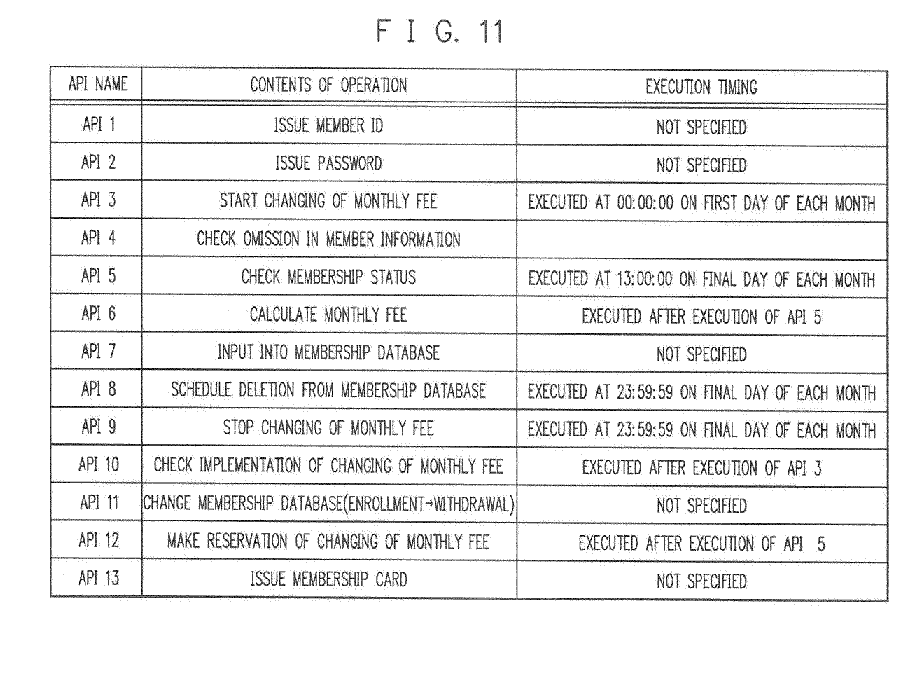

FIG 10 is a diagram showing an example of a correspondence relation in a case that the layer storage section 100 shown in FIG. 4 stores conversion definition information different for each module.

As shown in FIG. 10, in the layer storage section 100 shown in FIG 4, a layer identifier, a module identifier, and conversion definition information are stored in correspondence to each other. The module identifier is information used for identifying a module called from the module storage section 300 by a started program.

For example, as shown in FIG. 10, a layer identifier “L01”, a module identifier “module 3”, and conversion definition information “+1555200 seconds” are stored in correspondence to each other. Further, the layer identifier “L01”, a module identifier “module 6”, and a conversion definition information “+555860 seconds” are stored in correspondence to each other. Thus, in a case that the layer identifier “L01” is specified in the program executed by the control section 220, when the program calls the “module 3”, the date and time conversion section 230 converts the present date and time acquired from the clock 210 into a date and time obtained by adding “1555200 seconds” to the present date and time. Further, when the program calls the “module 6”, the date and time conversion section 230 converts the present date and time acquired from the clock 230 into a date and time obtained by adding “1555860 seconds” to the present date and time.

Further, a layer identifier “L02”, a module identifier “module 1”, and conversion definition information “−21600 seconds” are stored in correspondence to each other. Further, the layer identifier “L02”, a module identifier “another”, and a conversion definition information “−21800 seconds” are stored in correspondence to each other. Thus, in a case that the layer identifier “L02” is specified in the program executed by the control section 220, when the program calls the “module 1”, the date and time conversion section 230 converts the present date and time acquired from the clock 210 into a date and time obtained by subtracting “21600 seconds” from the present date and time. Further, when the program calls the another module, the date and time conversion section 230 converts the present date and time acquired from the clock 210 into a date and time obtained by subtracting “21800 seconds” from the present date and time.

Further, a layer identifier “L03”, a module identifier “module 3”, and conversion definition information “23:50:00 on Feb. 28, 2016” are stored in correspondence to each other. Further, a layer identifier “L03”, a module identifier “module 6”, and conversion definition information “00:01:00 on Feb. 29, 2016” are stored in correspondence to each other. Thus, in a case that the layer identifier “L03” is specified in the program executed by the control section 220, when the program calls the “module 3”, the date and time conversion section 230 converts the present date and time acquired from the clock 210 into “23:50:00 on Feb. 28, 2016”. Further, when the program calls the “module 6”, the date and time conversion section 230 converts the present date and time acquired from the clock 210 into “00:01:00 on Feb. 29, 2016”.

As such, when conversion definition information different for each module is set forth, flexibility is improved in a test of processing based on date and time information.

### Fourth Embodiment

Further, at the time of execution of a program using a timer, a virtual date and time may be set up. A fourth embodiment that a virtual date and time can be set up at the time of execution of a program using a timer is described below. The configuration of the fourth embodiment is the same as that shown in FIG. 4.

The second embodiment has been described for an exemplary case of a program executed with adopting as a trigger an instruction transmitted from the operator device 500-1 to 500-3. In contrast, the fourth embodiment is described below for an exemplary case of a program executed with adopting as a trigger the timing that a date and time set up in advance is reached. Further, a mode that a different virtual date and time can be set up for each module by using a technique different from the second embodiment is also described below.

FIG. 11 is a diagram showing an example of an API stored as a module in the module storage section 300 shown in FIG. 4.

As shown in FIG. 11, in the module storage section 300 shown in FIG. 4, an API name, the contents of operation, and an execution timing are stored in correspondence to each other. Two kinds of execution timings are used. One of these is that a trigger of the execution timing for the processing is transmitted from the operator devices 500-1 to 500-3 (32 not specified) and the other is that the processing is executed at a specified timing (such as the beginning or the end of each month) (=specified).

As an example, a program (referred to as an accounting program, hereinafter) is described below that performs accounting of the monthly fees of the members in a case that correspondence relations shown in FIG. 11 is stored in the module storage section 300. The accounting program performs the processing of generating a monthly fee of each member at the beginning of the month next to a month of utilization. Here, the accounting program extracts, as accounting objects, only members whose membership has been confirmed to be valid at 13:00 on the final day of the month of utilization, then calculates a utilization fee for each member serving as an accounting object, then charges the fee to the member's payment means (such as a credit card and a bank account), and then checks the charging after the accounting.

A flow of the processing of the accounting program is described below.

(1) Check that a membership is valid (API 5).

(2) Check a utilization fee of a month in which the membership has been confirmed to be valid (API 6).

(3) Make a reservation for execution of processing for the member to the accounting program (API 12).

(4) Perform the accounting (API 3).

(5) Check the accounting (API 10).

Here, the processing (1) is performed at 14:00 on the final day of a month of utilization. Further, the processing (4) is performed at 00:00 of the first day of the month next to the month of utilization. Thus, if the processing (1) and (4) were to be performed actually at specified timings, it would take a long time. Accordingly, a layer definition is set up in the accounting program and then the processing is performed by using a virtual date and time specified by layer definition.

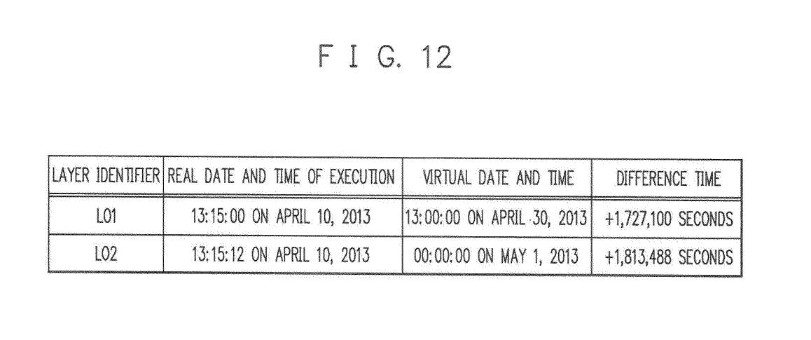

FIG. 12 is a diagram, showing an example of a layer definition stored in the layer storage section 100 shown in FIG 4.

As shown in FIG. 12, in the layer storage section 100 shown in FIG. 4, a layer identifier, a real date and time when processing is to be executed, a virtual date and time, and a time difference between these dates and times are stored in correspondence to each other as a layer definition. In the layer definition, a layer identifier “L01” is defined such that a real date and time 13:15:00 on Apr. 10, 2013 corresponds to a virtual date and time 13:00:00 on Apr. 30, 2013. Further, a layer identifier “L02” is defined such that a real date and time 13:15:12 on Apr. 10, 2013 corresponds to a virtual date and time 00:00:00 on May 1, 2013.

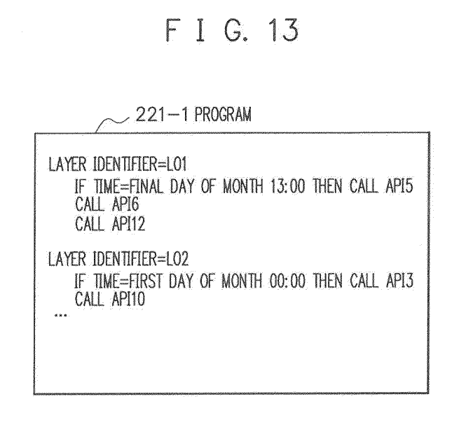

FIG. 13 is a diagram showing an example of an accounting program.

In the accounting program shown in FIG. 13, the API 5, the API 6, and API 12 are called and executed by using the virtual date and time defined, in correspondence to the layer identifier “L01”. After that, the API 3 and API 10 are called and executed by using the virtual date and time defined in correspondence to the layer identifier “L02”.

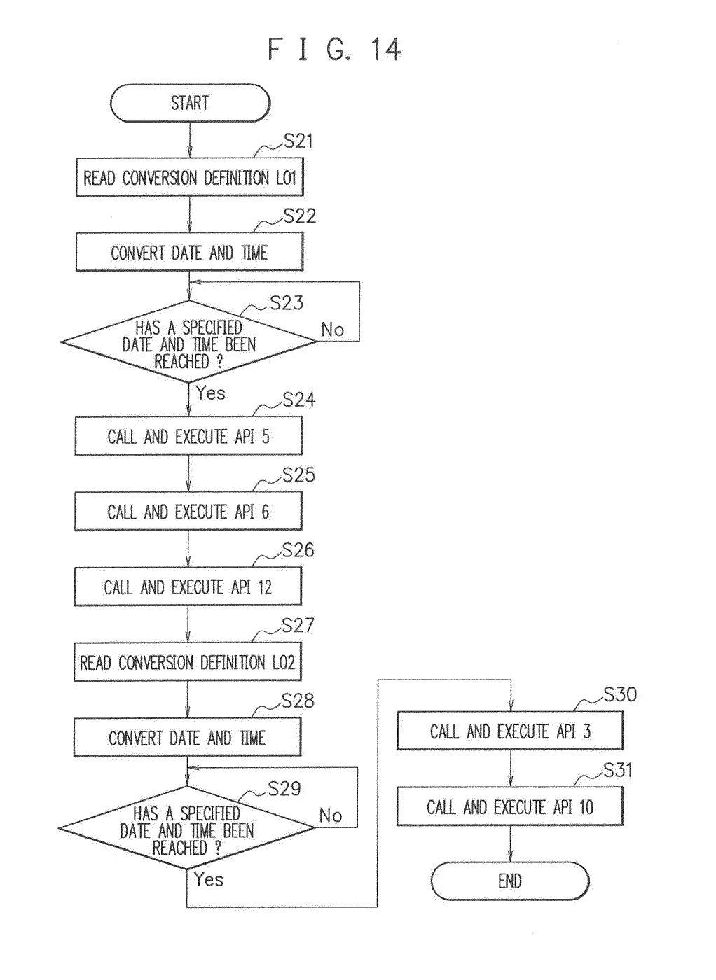

FIG. 14 is a flow chart used for describing processing in a case that a layer definition Shown in FIG. 12 is defined in the layer storage section 100 and then an accounting program shown in FIG. 13 is executed.

First, when the control section 220 executes the program 221-1 serving as an accounting program, the control section 220 outputs to the date and time conversion section 230 a date and time conversion instruction for converting the present date and time, together with the layer identifier “L01” defined first, and then monitors the time of day outputted from the date and time conversion section 230. Them the date and time conversion section 230 reads, from the layer storage section 100, conversion definition information corresponding to the layer identifier “L01” outputted from the control section 220 (step S21). Further, on the basis of the read-out conversion definition, the date and time conversion section 230 adds 1727100 seconds to the real date and time indicated by the clock 210, so as to convert the real date and time into a virtual date and time (step S22). Then, the date and time conversion section 230 outputs virtual date and time information indicating the virtual date and time, to the control section 220.

Then, when the virtual date and time indicated by the virtual date and time information outputted from the date and time conversion section 230 reaches 13:00:00 on Apr. 30, 2013 set up as the final day of the month of utilization (step S23), the control section 220 calls the API 5 from the module storage section 300 and then executes the API 5 (step S24). The API 5 is a module for performing the processing of extracting, as accounting objects, only members whose membership has been confirmed to bevalid. When the processing of the API 5 has been completed, the control section 220 calls the API 6 from the module storage section 300 and then executes the API 6 (step S25). The API 6 is a module for performing the processing of calculating a utilization fee of each member serving as an accounting object. Further, when the processing of the API 6 has been completed, the control section 220 calls the API 12 from the module storage section 300 and then executes the API 12 (step S26). The API 12 is a module for making an accounting reservation to the payment means of the member serving as an accounting object.

As such, in the APIs 5, 6, and 12, the layer identifier “L01” is set up as the layer definition. Thus, at the time that the date and time is referred to within the module, with including the layer definition, the control section 220 transmits to the date and time conversion section 230 a date and time request instruction for requesting the present date and time. Then, the date and time conversion section 230 returns a virtual time obtained by adding 1727100 seconds to the real time corresponding to the layer identifier “L01”.

The control section 220 outputs to the date and time conversion section 230 a date and time conversion instruction for converting the present date and time, together with the layer identifier “L02” defined next, and then monitors the time of day outputted from the date and time conversion section 230. Then, the date and time conversion section 230 reads, from the layer storage section 100, conversion definition information corresponding to the layer identifier “L02” outputted from the control section 220 (step S27). Further, on the basis of the read-out conversion definition, the date and time conversion section 230 adds 1833488 seconds to the real date and time indicated by the clock 210, so as to convert the real date and time into a virtual date and time (step S28). Then, the date and time conversion section 230 outputs virtual date and time information indicating the virtual date and time, to the control section 220.

Then, when the virtual date and time indicated by the virtual date and time information outputted from the date and time conversion section 230 reaches 00:00:00 on May 1, 2013 set up as the first day of the month next to the month of utilization (step S29), the control section 220 calls the API 3 from the module storage section 300 and then executes the API 3 (step S30). The API 3 is a module for performing accounting to the member's payment means to which an accounting reservation has been made. When the processing of the API 3 has been completed, the control section 220 calls the API 10 from the module storage section 300 and then executes the API 10 (step S31). The API 10 is a module for checking that the accounting has been performed correctly.

As such, in the APIs 3 and 10, the layer identifier “L02” is set up as the layer definition. Thus, at the time that the date and time is referred to within the module, with including the layer definition, the control section 220 transmits to the date and time conversion section 230 a date and time request instruction for requesting the present date and time. Then, the date and time conversion section 230 returns a virtual time obtained by adding 1813488 seconds to the real time corresponding to the layer identifier “L02”.

When the APIs 5, 6, 12, 3, and 10 are executed in a real date and time, the processing from (1) to (5) requires a processing time of 10 hours or more. On the other hand, when a different layer definition for each module is set up like In the present embodiment, evaluation can be performed such that a waiting time is not generated until the processing time is completed.

Here, when the instruction transmitted from the operator devices 500-1 to 500-3 is desired to be executed not immediately by the control section 220, a batch file including a processing instruction containing a member ID and a service identifier and date and time information indicating a date and time when the processing instruction is to be transmitted to the evaluation device may be transmitted from the operator devices 500-1 to 500-3 through the network 600 to the evaluation devices 200-1 and 200-2 and then stored into the storage sections of the evaluation devices 200-1 and 200-2. Then, the evaluation devices 200-1 and 200-2 may execute the processing instruction when the present date and time indicated by the clock 210 reaches the date and time indicated by the date and time information included in the stored batch file. Alternatively, a batch device for storing the batch file may be provided separately. Then, the batch device may store the batch file and then transmit the processing instruction to the evaluation devices 200-1 and 200-2. Further, a trigger of program execution start may be a timing that a timer provided in each of the evaluation devices 200-1 and 200-2 indicates a specified date and time.

As described above, in the present invention, in a program for testing, a configuration is employed that a definition of conversion, to a virtual date and time is specified, then by using the specified conversion definition, the present date and time acquired from a system clock is converted into a virtual date and time, and then processing is performed by using the virtual date and time. Thus, the test can be performed without restriction imposed depending on the implementation status of another test.

The processing performed by each component provided in the evaluation devices 200-1 and 200-2 described above may be performed by a logical circuit fabricated in accordance with each purpose. Further, a computer program (referred to as a program, hereinafter) describing the contents of the processing as a procedure may be recorded into a recording medium capable of being read by the evaluation devices 200-1 and 200-2. Then, the program recorded in the recording medium may be read and executed by the evaluation devices 200-1 and 200-2. Examples of the recording medium capable of being read by the evaluation devices 200-1 and 200-2 include: a removable recording medium such as a floppy (registered trademark) disc, a magneto-optical disc, a DVD, and a CD; a memory such as a ROM and a RAM built in the evaluation devices 200-1 and 200-2; and an HDD. Alternatively, a server device or the like connected to the evaluation devices 200-1 and 200-2 through a network may be employed. The program recorded in the recording medium is read by a CPU (not shown) provided in each of the evaluation devices 200-1 and 200-2 and then processing similar to the above-mentioned one Is performed under the control of the CPU. Here, the CPU serves as a computer for executing the program read from the recording medium storing the program.

The whole or part of the exemplary embodiments disclosed above can be described as, but not limited to, the following supplementary notes.

(Supplementary note 1) An evaluation system comprising:
layer storage means for storing in advance in correspondence to each other a layer identifier and conversion definition information used for converting a date and time;
a clock indicating a present date and time;
control means for outputting a specified layer identifier and a date and time conversion instruction; and
date and time conversion means for, when the date and time conversion instruction has been outputted from the control means, acquiring a present date and time from the clock, then on the basis of the layer identifier outputted from the control means, reading, from the layer storage means, conversion definition information corresponding to the layer identifier, then by using the read-out conversion definition information, converting the acquired present date and time, and then outputting, to the control means, virtual date and time information indicating the date and time obtained by conversion, wherein
the control means executes predetermined processing by using the date and time indicated by the virtual date and time information outputted from the date and time conversion means.
   (Supplementary note 2) The evaluation system according to Supplementary note 1, wherein:
the layer storage means stores information indicating a predetermined date and time as the conversion definition Information; and
the date and time conversion means converts the acquired present date and time into the predetermined date and time, then calculates and stores a difference between the present date and time and the predetermined date and time, and then when the date and time conversion instruction has been outputted next, converts the present date and time by using the stored difference.
   (Supplementary note 3) The evaluation system according to Supplementary note 1, wherein:
the layer storage means stores difference information as the conversion definition information; and
the date and time conversion means converts the acquired present date and time into a date and time obtained by adding a time indicated by the difference information to a date and time obtained by subtracting a time indicated by the difference information from the acquired present date and time or alternatively to the acquired present date and time.
   (Supplementary note 4) The evaluation system according to any one of Supplementary notes 1 to 3, including
an operator device operated by an operator who performs evaluation of a system by using the evaluation system, wherein:
the operator device transmits to the control means an instruction corresponding to operation of the operator; and
the control means starts up in response to an instruction transmitted from the operator device, and then transmits a result of execution of the processing to the operator device.
   (Supplementary note 5) The evaluation system according to Supplementary note 4, wherein
the control means is provided in an evaluation device for performing evaluation in accordance with an instruction transmitted from the operator device.
   (Supplementary note 6) The evaluation system according to Supplementary note 5, wherein
a plurality of evaluation devices similar to the evaluation device described above are provided.
   (Supplementary note 7) The evaluation system according to any one of Supplementary notes 1 to 6, wherein
the layer storage means stores a plurality of correspondence relations between the layer identifier and the conversion definition information.
   (Supplementary note 8).The evaluation system according to any one of Supplementary notes 1 to 7, wherein
the control means executes, as the predetermined processing, processing specified by a program stored in advance.
   (Supplementary note 9) An evaluation device comprising:
a clock indicating a present date and time;
a control section for outputting a specified layer identifier and a date and time conversion instruction; and
a date and time conversion section for, when the date and time conversion instruction has been outputted from the control section, acquiring a present date and time from the clock, then on the basis of the layer identifier outputted from the control section, acquiring conversion definition information serving as information defined in advance for the purpose of conversion of a date and time, then by using the acquired conversion definition information, converting the acquired present date and time, and then outputting, to the control section, virtual date and time information indicating the date and time obtained by conversion, wherein
the control section executes predetermined processing by using the date and time indicated by the virtual date and time information outputted from the date and time conversion section.
   (Supplementary note 10) The evaluation device according to Supplementary note 9, comprising a layer storage section for storing a correspondence relation between the layer identifier and the conversion definition information, wherein
the date and time conversion section reads, from the layer storage section, conversion definition information corresponding to the layer identifier outputted from the control section, so as to acquire the conversion definition information.
   (Supplementary note 11) An evaluation method comprising:
the step of an evaluation device, on the basis of the specified layer identifier, acquiring conversion definition information serving as information defined in advance for the purpose of conversion of a date and time;
the step of the evaluation, device acquiring a present date and time;
the step of the evaluation device, by using the acquired conversion definition information, converting the acquired present date and time; and
the step of the evaluation device, by using the date and time obtained by conversion, executing predetermined processing.
   (Supplementary note 12) The evaluation method according to Supplementary note 11, wherein
the evaluation device searches a layer storage section for storing a correspondence relation between the layer identifier and the conversion definition, information, and then reads, from the layer storage section, conversion definition, information corresponding to the specified layer identifier, so as to acquire the conversion definition information.
   (Supplementary note 13) A recording medium recording a program for causing
a computer to execute:
the procedure of, on the basis of a specified layer identifier, acquiring conversion definition information serving as information defined in advance for the purpose of conversion of a date and time;
the procedure of acquiring a present date and time;
the procedure of, by using the acquired conversion definition information, converting the acquired present date and time; and
the procedure of, by using the date and time obtained by conversion, performing predetermined processing.

### Description of Reference Numerals

100 Layer storage section
200-1, 200-2 Evaluation device
210 Clock
220 Control section
221-1 to 221-3 Program
230 Date and time conversion section
300 Module storage section
400 Membership database
500-1 to 500-3 Operator device
600 Network

What is claimed is:

1. An evaluation system comprising:
layer storage means for storing in advance in correspondence to each other a layer identifier and conversion definition information used for converting a date and time;
a clock indicating a present date and time;
control means for outputting a specified layer identifier and a date and time conversion Instruction; and
date and time conversion means for, when the date and time conversion instruction has been outputted from the control means, acquiring a present date and time from the clock, then on the basis of the layer identifier outputted from the control means, reading, from the layer storage means, conversion definition information corresponding to the layer identifier, then by using the read-out conversion definition information, converting the acquired present date and time, and then outputting, to the control means, virtual date and time information indicating the date and time obtained by conversion, wherein
the control means executes predetermined processing by using the date and time indicated by the virtual date and time information outputted from foe date and time conversion means.

2. The evaluation system according to claim 1, wherein:
the layer storage means stores information indicating a predetermined date and time as the conversion definition information; and
the date and time conversion means converts the acquired present date and time into the predetermined date and time, then calculates and stores a difference between the present date and time and the predetermined date and time, and then when the date and time conversion instruction has been outputted next, converts the present date and time by using the stored difference.

3. The evaluation system according to claim 1, wherein:
the layer storage means stores difference information as the conversion definition Information; and
the date and time conversion means converts the acquired present date and time into a date and time obtained by adding a time indicated by the difference information to a date and time obtained by subtracting a time indicated by the difference information from the acquired present date and time or alternatively to the acquired present date and time.

4. The evaluation system according to claim 1, including
an operator device operated by an operator who performs evaluation of a system by using the evaluation system, wherein;
the operator device transmits to the control means an instruction corresponding to operation of the operator; and
the control means starts up in response to an instruction transmitted from the operator device, and then transmits a result of execution of the processing to the operator device.

5. The evaluation system according to claim 4, wherein
the control means is provided in an evaluation device for performing evaluation in accordance with an instruction transmitted from the operator device.

6. The evaluation system according to claim 5, wherein
a plurality of evaluation devices similar to the evaluation device described above are provided.

7. The evaluation, system according to claim 1, wherein
the layer storage means stores a plurality of correspondence relations between the layer identifier and the conversion definition information.

8. The evaluation system according to claim 1, wherein
the control means executes, as the predetermined processing, processing specified by a program stored in advance.

9. An evaluation device comprising:
a clock indicating a present date and time;
a control section for outputting a specified layer identifier and a date and time conversion instruction; and
a date and time conversion section for, when the date and time conversion instruction has been outputted from the control section, acquiring a present date and time from the clock, then on the basis of the layer identifier outputted from the control section, acquiring conversion definition information serving as information defined in advance for the purpose of conversion of a date and time, then by using the acquired conversion definition information, converting the acquired present date and time, and then outputting, to the control section, virtual date and time information indicating the date and time obtained by conversion, wherein
the control section executes predetermined processing by using the date and time indicated by the virtual date and time information outputted from the date and time conversion section.

10. The evaluation device according to claim 9, comprising
a layer storage section for storing a correspondence relation between the layer identifier and the conversion definition information, wherein
the date and time conversion section reads, from the layer storage section, conversion definition information corresponding to the layer identifier outputted from the control section, so as to acquire the conversion definition information.

11. An evaluation method comprising:
the step of an evaluation device, on the basis of the specified layer identifier, acquiring conversion definition information serving as information defined in advance for the purpose of conversion of a date and time;
the step of the evaluation, device acquiring a present date and time;
the step of the evaluation device, by using the acquired conversion definition information, converting the acquired present date and time; and
the step of the evaluation device, by using the date and time obtained by conversion, executing predetermined processing.

12. The evaluation method according to claim 11, wherein
the evaluation device searches a layer storage section for storing a correspondence relation between the layer Identifier and the conversion definition information, and then reads, from the layer storage section, conversion definition information corresponding to the specified layer identifier, so as to acquire the conversion definition information.
